(19) United States
(12) Patent Application Publication
(10) Pub. No.: US 2025/0378194 A1
(43) Pub. Date: Dec. 11, 2025

(54) Integration Software-toolkit for Integrating Sensitive Data Protection-Systems with Enterprise Databases

(71) Applicant: Jordan Naod, Flushing, NY (US)

(72) Inventor: Jordan Naod, Flushing, NY (US)

(21) Appl. No.: 19/229,343

(22) Filed: Jun. 5, 2025

Related U.S. Application Data
(60) Provisional application No. 63/657,013, filed on Jun. 6, 2024.

(51) Int. Cl. G06F 21/62

(52) U.S. Cl. CPC G06F 21/6245; G06F 2221/2101

(57) ABSTRACT

The integration software toolkit has four core components: “Control Cube”, “Discovery”, “Qualifier” & “Resolution”. The “Control Cube” core component primary capabilities are to transmit functional instructions and serve as gateways to interact with backend and frontend system functions. The “Discovery” core component correct data stores sensitive data elements. The “Qualifier” core component retains real-time sensitive data compliance policies, which will be used to determine whether an offshore, nearshore or onshore production support engineer can or cannot see sensitive data at the database field-level. The “Resolution” Reactive-AI core component main capability is to perform sensitive data error resolutions with no human involvements if offshore or nearshore support engineers are denied access. The integration software toolkit can be implemented at any industry (i.e., healthcare, finance, banks, retail & airline), which are storing sensitive data for daily operations; and seamlessly configurable to align with their specific use cases and data compliance requirements.

This invention relates to the integration of sensitive data protection technologies with enterprise's databases; and to an integration software-toolkit that enables enterprises to seamlessly integrate their operational databases with sensitive data protection technologies.

### BACKGROUND OF THE INVENTION

I have been studying, consulting sensitive data element protection technologies' integration with core systems and operation's use cases for a decade. According to the result of my research and my experience as a consultant in the field, sensitive data elements protection systems are created to provide data protection services only by encrypting sensitive data elements in databases; and they are effective in providing protection services (i.e., encrypting sensitive data elements at-rest & in-use). However, contemporarily, the sensitive data elements protection service providers and the IT industry in general do not have any enterprise extension software-toolkit that seamlessly integrate the sensitive data elements protection technologies with an enterprise's operational databases. Thus, this limitation is hindering global industries (i.e., finance, bank, healthcare, aviation & retail), which are not able to successfully integrate the sensitive data elements protection technologies with their enterprise databases.

Consequently, the above industries have found themselves in major difficulties in the process of achieving the industry standard sensitive data protection “Compliance” of HIPAA (healthcare Insurance Portability & Accountability Act of 1996) and SOX (Sarbanes-Oxley Act of 2002) policies. Hence, the technological gap and the limitation noted are causing some of the following extreme challenges that enterprises are experience when implementing a vendor-based sensitive data protection technologies for their enterprises:
High financial burdens—Enterprises spend enormous amount of money to create their own enterprise's extension systems to integrate with the sensitive data protection technologies to implement and operationalize sensitive data protection systems in production, so that they can achieve industry standard sensitive data protection compliance. Hence, this by itself becomes a massive project, costing enormous amount of money to develop these extension systems just to integrate the sensitive data protection technology with the enterprise core systems, various of platform environments, business use cases and geo-based production system's supports scenarios.
Tech-debts—The creation of high numbers of extension systems increases the amount of configuration items within the enterprise tech—catalogue causing “tech-debts” because similar extension systems might be developed across the different domains of the enterprise. As a result, this scenario further causes the enterprises in a major financial burden for on-going production support of these extension systems.
Implementation Challenges—During the development phase of the extension systems, deliverable schedules might be delayed depending on the complexity of the use cases, trials & errors etc. Most frequently, this causes a major delay for the overall integration phase of the vendor-based sensitive data protection technology with the enterprises core use cases and domains. Consequently, it causes enterprises to change their global production operating model (i.e., geo-based offshore/nearshore production systems support engineering teams) to onshore and that increases their operation's supports cost, enormously.

### SUMMARY OF THE INVENTION

As discussed above, contemporary vendor-based sensitive data protection technologies and the general IT industry do not have any advanced and cost-efficient solutions to enable any enterprise to integrate the sensitive data protection technologies with their enterprise operational databases as well as business use cases. To overcome this technological limitation, I designed a cost-effective integration software-toolkit as a solution, which has four integrated components (Discovery, Qualifier, Resolution & Control-Cube) with advanced “Reactive-AI” capabilities and features. This advanced integration software-toolkit's four core components are going to be developed using API based microservices development pattern in combination with REST API (representational state transfer—application programming interfaces) framework, event-driven pattern with webhook & protocols to integrate the four components. In addition, Java Script with React framework will be used to develop the frontends user interface and Python programing language will be used for the backends (server level functions) for the four components. The source codes will be packaged & containerized with docker technology to ensure platform portability (i.e., Kubernetes, hybrid cloud, multi-cloud & on premises), scalability, high-availability, security and cost efficient for on-going production supports. Thus, the integration software-toolkit will be used as a configurable integration platform will be used by the Information Technology industry, Sensitive Data Protection & Compliance practices and by industries (i.e., financial, banking, healthcare, aviation & retail) that possess sensitive data elements to achieve the following goals:
Achieving industry standards sensitive data protection compliances (i.e., HIPAA—Health Insurance Portability & Accountability Act of 1996 and SOX-Sarbanes-Oxley Act of 2002).
Maintaining cost-efficient operating model (by sustaining global-based offshore/nearshore production system's support engineering teams), which also adds value to the growth of the global economy and division of specialized-labor distributions.
Leveraging the integration software-toolkit platform advance capabilities as an enterprise extension system to successfully integrate any vendor-based sensitive data protection technology with an enterprise's operational databases, platform environments and business use cases by ensuring on-time delivery to control costs.
Implementing the integration software-toolkit as a customizable platform ensures that enterprises will not possess any “tech-debt” because they will not be creating any redundant extension systems across the different domains of their enterprises preventing unnecessary “integration delivery-delays” while performing lengthy trial and errors.

### BRIEF DESCRIPTION OF DRAWINGS

FIG. 1 represents “Control Cube”, which is the found of the integration core component of the integration software-toolkit that is integrated with the following core components: FIG. 2 (“Discovery”), FIG. 3 (“Qualifier”), FIG. 4 (“Resolution”) core components. The “Control Cube” core component is developed using Python programming language for its backend REST API based microservices and Java Script with React framework for its frontend user interfaces. The source codes are packaged and containerized by Docker technology to ensure deployment platform portability, scalability and high availability.

FIG. 2 represents “Discovery” core component; and its primary purpose is to store sensitive data elements correct data value, verify correct data value of sensitive data elements and assigning sensitive data related support tasks to production supports engineering teams. The “Discovery” core component is developed using Python programming language for its backend REST API based microservices and Java Script with React framework for its frontend user interfaces. The source codes are packaged and containerized by Docker technology to ensure deployment platform portability, scalability and high availability. As depicted in the diagram, the “Discovery” core component is integrated with the following core components: FIG. 1 (“Control Cube”) to exchange and transmit instruction to pull sensitive data elements, FIG. 3 (“Qualifier”) to allow the production support engineering teams view correct data value of sensitive data elements to enable them perform updates in the target production databased field-level and with FIG. 4 (“Resolution”) Reactive-AI to provide details of correct data value of sensitive data elements including the target production database environmental attributes, so that the “Resolution” Reactive-AI core component is able to perform tasks in the production databases without human involvements.

FIG. 3 represents “Qualifier” core component; and its primary purpose is to store real-time sensitive data compliance policies for each sensitive data element based on geo-location (i.e., offshore, nearshore & onshore) to determine attribute-based access at the database field-level. The primary end users are the Enterprise data governance teams, sensitive data compliance policy makers, risk prevention & management teams and other stakeholders that have data protection or policy related decision-making responsibilities and designated members from industry sensitive data compliance agencies (HIPAA, SOX) etc. The “Qualifier” core component is developed using Python programming language for its backend REST API based microservices and Java Script with React framework for its frontend user interfaces. The source codes are packaged and containerized by Docker technology to ensure deployment platform portability, scalability and high availability.

FIG. 4 represents “Resolution” Reactive-AI; and its primary purpose is to perform sanative data related error resolutions in the production database field-level if a production support engineer is denied access. Only the production support engineering teams are the end users to trigger the Reactive-AI to perform that sensitive data error resolutions. As can be seen on the diagram, FIG. 4 is directly integrated with FIG. 1 (“Control Cube”) core component to get the trigger instruction. It is also directly integrated with FIG. 2 (“Discovery”) core component to learn correct data value of sensitive data element including the target production databases environmental attributes (connectors, IP & DNS). FIG. 4 is not integrated with FIG. 3 (“Qualifier”), as there is no functional relationship between the two core components. The “Resolution” Reactive-AI is developed using Python programming language for its backend server level REST API microservices and Java Scripts with React framework for its frontend user interfaces. The Docker technology will be used to package and containerize the source codes for deployment platform portability, scalability and availability purposes. In addition, Event-Driven architectural pattern using the method of Webhook for its communication between itself and the target production database servers to perform its tasks.

### DETAILED DESCRIPTION OF THE INVENTION

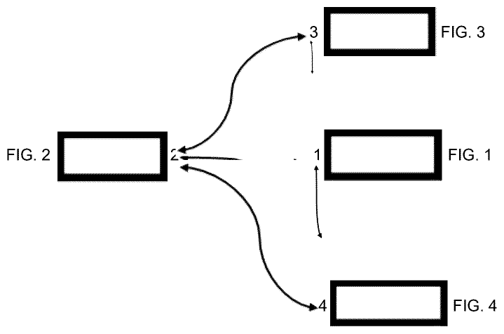

5. As described in the previous sections of this application, contemporary vendor-based sensitive data protection technologies and the general IT industry do not have any advanced and cost-efficient solutions to enable any enterprise to integrate the sensitive data protection technologies with their enterprise operational databases. To solve this technological limitation, I have invented the integration software-toolkit, which has 4 core integrated components illustrated in the drawing section. Each core component's tech-stacks, integration, capabilities and processes are described, below. The 1st core component is “Control Cube” (FIG. 1 on the diagram) that serves as a common denominator (main) core component of the integration software-toolkit. “Control Cube” will be developed as a REST API based microservices patter using Python programming language for its backend (server level source codes) and Java Script with React framework for its frontend (user interfaces) to provide critical services (i.e., request translation, interpretation, communication, data transmission, attribute based-security authorization). “Control Cube” integrates and/or interfaces with the rest of the three internal core components (Discovery, Qualifier & Resolution) and other external enterprises' core systems, which are described, below:
“Control Cube” integrates with any enterprises' RBAC (role-based access control) authentication technologies for IAM (identity access management). The major technological gap is that currently there is no ABAC (attribute-based access control) enterprise suite to provision database field-level fine-graine access services for complex use cases of global enterprises that have (i.e., about 90% of their production supports teams operating offshore/nearshore) to perform sensitive data related tasks.
“Control Cube” integrates with the “Qualifier” (core component #3 FIG. 3 on the diagram), which serves as a compliance policy engine to determine whether offshore/nearshore support teams can or cannot see sensitive data elements inbound at the database field-level.
“Control Cube” integrates with the “Resolution” (FIG. 4 in the diagram), which is a “Reactive-AI” with capabilities of performing sensitive data error resolutions without any human involvement if a given offshore/onshore support engineer is denied access to perform his/her tasks to resolve sensitive data error at the database field-level. Thus, “Control Cube” transmit resolution instructions to the “Resolution” component to resolve.
“Control Cube” integrates with enterprises' sensitive data protection systems to transmit specific instructions to decrypt, re-encrypt, detokenize or retokenize sensitive data elements at the database field-level.

The primary end users of the “Control Cube” core components are the following stakeholders: Production support engineer teams, business support teams that are located offshore, nearshore and onshore.

The 2nd core component is “Discovery” (FIG. 2 in the diagram), which stores correct data value of any sensitive data elements. To develop the “Discovery” REST API based microservices component, Python programming language is used to develop its backend server level source cords, Java Script with React framework is used it develop its frontend for its user interfaces. The “Discovery” core component is used by the business support teams and technical teams or end users to capture as well store the correct data value of any sensitive data elements in industries that use and store sensitive data elements for their daily business operation. The following are two business use cases and their processes that the “Discovery” core component solves:
The primary business use case process is that “Discovery” receives primary key values from the “Qualifier” core component whenever access to the sensitive data element is granted to the offshore/nearshore support engineering teams based on Geo-location of the requester and the value of the compliance policy associated to the specific sensitive data element. As soon as “Discovery” receives the primary key value from the “Qualifier”, it means that “Discovery” grants the details of the correct data value of the sensitive data element to the designated offshore/nearshore support engineer. The support engineer uses “Control Cube” core component to insert the correct data value and “Control Cube” sends instructions to the data protection system to decrypt the database fields, so that the support engineer can perform the required updates to the sensitive data elements.
The 2nd business use case process is that “Discovery” core component provides sensitive data element correct data value and attributes of the target production operational database (i.e., connectors, IP & DNS) to the “Resolution” (Reactive-AI) core component, so that it can perform the required updates in the production operational database without any human involvements. This scenario happens if the designated offshore/nearshore support engineer is denied access by the “Qualifier” core component.
The 3rd core component is “Qualifier” (FIG. 3 in the diagram), which will be developed to retain real-time sensitive data compliance policies associated with each sensitive data element. Note that every industry (i.e., financial, bank, aviation, retail or healthcare) has its own unique sensitive data element and the “Qualifier” is a critical component that retains the specific sensitive data element policies as a source of truth. The “Qualifier” core component is going to be used by the following stakeholders: Enterprise data governance teams, sensitive data compliance policy makers, risk prevention & management teams and other stakeholders that have data protection or policy related decision-making responsibilities and designated members from industry sensitive data compliance agencies (HIPAA, SOX) etc. The “Qualifier” REST API based microservices will be developed using Python language for its backend and Jave Scrip with React framework for its frontend user interfaces. The “Qualifier” core component integrates with the “Control Cube” core component, so that industry standard compliance policies for attribute-based access control at the database field level is successfully enforced. Furthermore, the “Qualifier” core component ensures that there will be a real-time and measurable compliance policies for attribute-based to determine whether offshore/nearshore support teams can or cannot see specific sensitive data element depending on the value of compliance policy for the sensitive data element at the time of a given request and the geo-location of the requester. Based on the result, if the requested sensitive data elements can be seen, then the “Qualifier” allows the request to access the “Discovery” core component to view the details of the correct data value of the specific sensitive data element, so that the requestor can perform system support tasks in the production operational database field-level. However, if access is denied by the “Qualifier”, then the requester is routed to the main “Control Cube” user interface to trigger the “Resolution” Reactive-AI core component, so that the “Reactive-AI” can perform the updates on the database field-level and this process is further elaborated below on the “Resolution” core component paragraph.
The 4th core component is the “Resolution” Reactive-AI component that has the capabilities to perform sensitive data error resolutions with no human involvements. The “Resolution” Reactive-AI will be developed using Python programming language to create its backend server level functions for its REST API microservices and the source codes will be packaged and containerized with Docker technology for deployment platform portability, scalability and high-availability purposes. In addition, I'll implement the Event-Driven Webhook pattern for communication and transmission of execution instruction between the “Resolution” Reactive-AI & the target production database servers to perform the sensitive data error resolutions. The primary end users of the “Resolution” Reactive-AI are the production support engineer teams that are located offshore, nearshore and onshore. The “Resolution” Reactive-AI main capability is to perform sensitive data error resolution tasks at the production database field-level with no human involvement if a given offshore/nearshore support engineer is denied access to perform sensitive data error resolution tasks. As a result, the “Resolution” Reactive-AI core component helps companies reduce production supports and operating cost because the automation capabilities can guarantee them to maintain global operating model to save supports cost. The “Resolution” Reactive-AI integrates with the “Discovery” and “Control Cube” core components to perform its capabilities, effectively. The “Resolution” Reactive-AI has one use case that has only two simplified steps to perform the sensitive data task in the production database field-level and the process is described, below:
The 1st step is triggered If the offshore/nearshore support engineer is denied access to the sensitive data element, he/she triggers the “Resolution” Reactive-AI by inserting the “Discovery” database primary key that he/she gets from the incident ticket. The “Resolution” Reactive-AI goes to the “Discovery” core component database to learn about the correct data value and related attributes about the target database environments (connectors, IP & DNS).
The 2nd step is for the “Resolution” Reactive-AI to directly connect to the target production database servers via the Webhook mechanism, so that it can perform sensitive data error resolutions in real-time. Once, it completes its error resolutions, it starts performs verification and validation by comparing the previous sensitive data value vs the correct sensitive data value. Thereafter, the “Resolution” Reactive-AI sends both data values to “Control Cube” repository, so that the real time corrected sensitive data values are retained for the purposes of audit trails, sensitive data compliance policy evaluation and industry standard data governance references.

1. An Integration software-toolkit that can be implemented to integrate sensitive data protection technologies with production databases for industries (i.e., healthcare, finance, bank, retail & airline), which are storing sensitive data elements for their daily operation; and these industries must have the following use cases:
Any of the noted industries or other enterprises that are storing sensitive data elements for their daily operation use the integration software-tool kit with its four core components: “Control Cube”, “Discovery”, “Qualifier” & “Resolution” Reactive-AI.
Any of the noted industries or other enterprise have offshore or nearshore production support engineering teams, then the integration toolkit is effective in provisioning attribute-based access using its four core components.
The “Discovery” core component is an effective application for enterprise that have business support teams and customer services to store correct data value of sensitive data elements.
The “Discovery” core component also serves as reference point for the production support teams that are granted access to view correct data value of sensitive data element, so that they perform updates at the production database field-level.
The “Qualifier” core component is one of the most critical components of the integration software-toolkit, which is easily configurable to align with any industry sensitive data compliance requirements and sensitive data use cases for provisioning fine-grained attribute-based access at the database field-level.
Each industry has its own specific sensitive datasets and compliance policies, so the “Qualifier” core component is effective for seamless customization to serve as an engine to storing compliance policies that align for the needs of the specific industry.
The “Resolution” Reactive-AI is an advanced core component of the integration software-toolkit that performs sensitive data error resolutions with no human involvements if the support engineers are demined access to perform their tasks.
Support engineers are the primary end users to trigger the “Resolutions” Reactive-AI; and it integrates with the “Discovery” to learn correct data values and the target production database environment platform attributes (i.e., connectors, IPs & DNS).
Once, it completes the resolution tasks, it validates previous sensitive data values vs. updated sensitive data values and sends to the “Control Cube” to retain for audit trail, compliance evaluation and future references.
